(19) United States
(12) Patent Application Publication
(10) Pub. No.: US 2014/0152857 A1
(43) Pub. Date: Jun. 5, 2014

(54) Camera Apparatus and System

(71) Applicant: Over-View Limited, London (GB)

(72) Inventors: David Watkins, London (GB); David Ellis, Clapham (GB); Swee Yeow Yap, Sutton (GB); Xing Yu, London (GB); Gareth Lott, London (GB); Sanjaya Ranasinghe, London (GB)

(73) Assignee: Over-View Limited, London (GB)

(21) Appl. No.: 14/175,324

(22) Filed: Feb. 7, 2014

Related U.S. Application Data
(63) Continuation of application No. PCT/GB2012/052418, filed on Sep. 28, 2012.

(30) Foreign Application Priority Data
Sep. 28, 2011 (GB) 116732.7

(51) Int. Cl. H04N 5/232; H04N 7/18

(52) U.S. Cl. CPC H04N 5/23206; H04N 7/18
USPC 348/207.11

(57) ABSTRACT

A camera apparatus is provided comprising a camera including camera control electronics and a control means, wherein the control means is located within the camera. A system is also provided comprising the camera apparatus and a remote control terminal in communication with the apparatus, wherein control of the camera is via a user interface generated at the control terminal from data signals received from the control means located within the camera.

### CROSS REFERENCE TO RELATED APPLICATIONS

This application is a continuation of PCT International Application No. PCT/GB2012/052418 filed Sep. 28, 2012 which claims priority to Great Britain Patent Application No. 1116732.7, filed Sep. 28, 2011, which are hereby incorporated by reference in their entirety.

### TECHNICAL FIELD

The present invention relates to a camera apparatus and system, for example a closed circuit television (CCTV) apparatus and system.

### BACKGROUND

In many existing CCTV systems, the camera is a zoom unit equipped with auto-focus, and can be moveable within the housing, or the housing itself is moveable, through control signals passed from control circuitry to drive circuitry on motors connected to the camera itself and/or or the housing. The movement of the camera is typically via a pan and tilt mechanism

The control circuitry typically comprises separate intelligent digital circuitry for controlling the movement of the camera, and also for performing additional CCTV functions, such as compression circuitry for digital transmission of the video or still image frames to an external destination, or circuitry for performing smart analytical processes on the video, or still image frames. In such existing systems, all of the intelligent CCTV functionality, such as control of the camera movement, video/image analysis and processing is performed by the control circuitry which is contained within the housing, but external to the camera itself.

FIG. 1 shows an existing camera system comprising an apparatus housing 10 which is a CCTV housing, such as a CCTV dome. The apparatus housing 10 can be fixed in a stationary position, for example on a wall mounting. Alternatively, the apparatus housing 10 itself can be moveable relative to a mounting element (not shown in FIG. 1).

FIG. 2 shows the arrangement of some of the internal, functional components of such an existing system 500. Further explanation about these functional components is set out below in the detailed description section. However, it is important to note the following information concerning certain features of the existing system 500.

A camera 12 is located in the apparatus housing 50. The camera 12 (which may have a camera housing 12a) includes camera electronics 56 which provides all conventional video/imaging functionality relating to video/image acquisition via an imaging component 20, such as a charge-coupled-device (CCD), or complimentary metal-oxide-semiconductor (CMOS) (see below).

Outside the camera 12 (and outside any existing camera housing 12a), but within the apparatus housing 50, there is control circuitry 58 which provides CCTV functionality including control of movement of motors 28 and the provision of a communication interface 52 which can be accessed remotely, e.g. from a remote terminal 14.

In existing systems, the control circuitry 58 and communication interface 52 are located in a fixed position within the apparatus housing 50, separately from the camera 12. The control circuitry 58 and communication interface 52 is necessary so that a remote user can control functions of the camera, particularly those required for performing CCTV functions. Such CCTV functions may include: controlling movement of the camera (e.g. pan and/or tilt), configuring display options of the user interface, configuring video settings of the camera control electronics, configuring video alarm settings, providing a programmable motion mask, providing a privacy cursor, providing a mosaic privacy patch, providing a color bar on a display screen of the device, providing a logo on a display screen of the apparatus, providing customization of colors, customization of color sets, customization of graphics or customization of logos, providing customization of languages on the user interface, or configuring a password for accessing the user interface.

Due to the variety and complexity of CCTV functions that may have to be supported, CCTV camera systems are highly cost sensitive.

It is therefore an aim of the present invention to provide all existing control functionality of CCTV camera systems, along with additional control functionality, whilst minimizing the need for complex, expensive and dedicated control circuitry.

### SUMMARY

In view of the foregoing and in accordance with a first aspect of the invention, there is provided an apparatus comprising:
a camera including camera control electronics; and
a control means,
wherein the control means is located within the camera.

Hence, the intelligent control circuitry of the control means providing CCTV functionality is placed within the camera, and within the camera housing, for example by using the existing camera electronics. This provides a very significant cost saving over the usual need to provide additional circuitry for drive power and general control.

Specific CCTV functions may include one or more of: controlling movement (e.g. pan and/or tilt) of the camera (either movement of the camera itself within a fixed, stationary apparatus housing, or movement of the apparatus housing relative to a fixed point), for example, the pan and tilt of the camera, or apparatus housing; configuring display options of the user interface; configuring image/video settings of the camera electronics; configuring video alarm settings; providing a programmable motion mask; providing a privacy cursor; providing a mosaic privacy patch; providing a color bar on a display screen of a remote terminal; providing a logo on a display screen of the remote terminal; providing customization of image/video frame colors; customization of color sets; customization of graphics or customization of logos used in the user interface; providing customization of languages on the user interface; or configuring a password for accessing the user interface.

The control means provides intelligent CCTV functionality, and the camera may, for example, be moveable under control of the control means.

The camera may be a video camera and/or a still image camera for acquiring image data being still frames or a succession of video frames. All control circuitry is placed within the camera itself, which can be done at very small incremental cost using components already present within the camera.

Preferably, the control means is integrated with the existing camera electronics built into the camera.

In one embodiment of the present invention, the camera electronics obtains charge coupled device (CCD) image data and/or complimentary metal-oxide-semiconductor (CMOS) image data from a CCD and/or CMOS of the camera. In a preferred embodiment of the present invention, the control means carries out image processing on the CCD and/or CMOS image data obtained by the camera control electronics from the CCD and/or CMOS of the camera. Preferably, the control means compresses the CCD and/or CMOS image data obtained by the camera control electronics from the CCD and/or CMOS of the camera.

Preferably, the control means comprises a communication interface for receiving and transmitting signals between the control means and a device situated at a location which is remote from the camera.

Therefore, the entire communication interface for controlling the camera is located within the camera itself.

In a preferred embodiment of the present invention, the control means is configured to generate a user interface which is viewable from the device at a location which is remote from the camera and is further configured to receive commands from the device at a location which is remote from the camera.

Preferably, the control means is configured to receive commands and provide control signals to the camera control electronics for controlling at least one function of the camera.

In one embodiment of the present invention, the control means provides control via the user interface of functions which comprise at least one of: configuring display options of the user interface, configuring video settings of the camera control electronics, configuring video alarm settings, providing a programmable motion mask, providing a privacy cursor, providing a mosaic privacy patch, providing a color bar on a display screen of the device, providing a logo on a display screen of the apparatus, providing customization of colors, customization of color sets, customization of graphics or customization of logos, providing customization of languages on the user interface, or configuring a password for accessing the user interface.

The user interface may be a web-accessible interface provided by the communication interface in the camera acting as a web server.

Since the control means and the camera control circuitry are located entirely within the camera, all of the functions listed above can be controlled from within the camera, and from outside the camera, via the communication interface.

The control means can be configured to receive remote control signals from the device at a location which is remote from the camera.

In another embodiment of the present invention, the camera is located in an apparatus housing. The apparatus housing may be a CCTV camera housing, such as a CCTV dome.

In another embodiment of the present invention, the apparatus comprises at least one motor for moving the apparatus housing and/or the camera within the apparatus housing. The apparatus can further comprise a motor drive means for driving the at least one motor under control of the control means. Preferably, the motor drive means is integrated with the at least one motor.

In another embodiment of the present invention, the control means is configured to receive commands and provide control signals for controlling movement of the at least one motor via the motor drive means. Preferably, the motor drive means and the control means communicate with each other via a signal which is generated and communicated entirely within the apparatus housing. Preferably, the motor drive means and the control means communicate with each other via a serial signal. Preferably, the motor drive means and the control means communicate with each other via an i2c serial signal generated by the control means.

In a preferred embodiment of the present invention, the at least one motor is a brushless motor. Preferably, the at least one motor is a brushless DC servo motor. Preferably, the at least one motor is configured to drive a load directly.

In another embodiment of the present invention, the control means is configured to provide control signals to one or both of the camera and/or the motor drive means so as to provide the functionality of a pan tilt zoom (PTZ) system.

In one embodiment of the present invention, the apparatus housing is stationary and the camera is moveable within the apparatus housing.

Alternatively, the apparatus housing can be connected to a mounting element, the apparatus housing can be moveable relative to the mounting element, and the camera can be moveable in conjunction with the apparatus housing relative to the mounting element.

Preferably, the control means is configured to provide control signals to the motor drive means to control at least one of rotation of the apparatus housing about the mounting element and/or tilt of the apparatus housing relative to the mounting element.

Preferably, the control means is configured to provide control signals to the camera control electronics to control at least one of zoom drive, focus drive, provision of auto-focus, automatic iris adjustment, iris adjustment under control of an external source, automatic filter adjustment, filter adjustment under control of an external source, adjustment of exposure speed, adjustment of exposure settings, white/color balance adjustment, or provision of privacy patches.

There is also provided a system comprising: the apparatus of any one of the claims; and a remote control terminal in communication with the apparatus, wherein control of the camera is via a user interface generated at the control terminal from data signals received from the control means located within the camera.

### BRIEF DESCRIPTION OF THE DRAWINGS

The invention will now be described by way of example with reference to the accompanying drawings, in which:

FIG. 1 shows a perspective view of an existing camera apparatus housing;

FIG. 2 shows a schematic view of an existing camera system incorporated into the apparatus housing of FIG. 1;

FIG. 3 shows a schematic view of a camera system according to an embodiment of the present invention;

FIG. 4 shows a schematic view of camera electronics of a camera according to an embodiment of the present invention.

### DETAILED DESCRIPTION OF ILLUSTRATIVE EMBODIMENTS

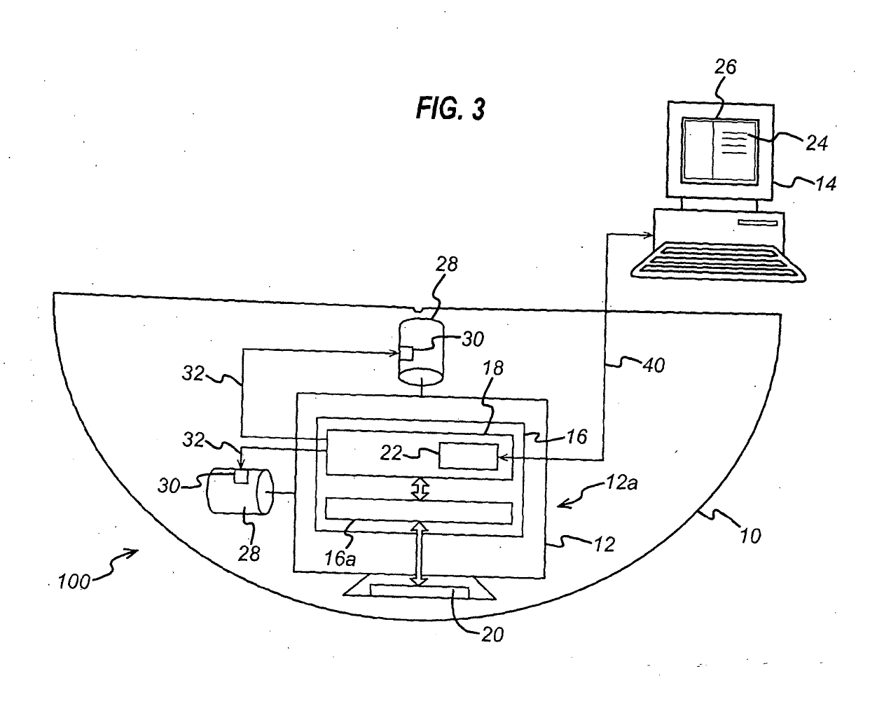

The present invention is now described with reference to an exemplary embodiment depicted in FIGS. 3 and 4.

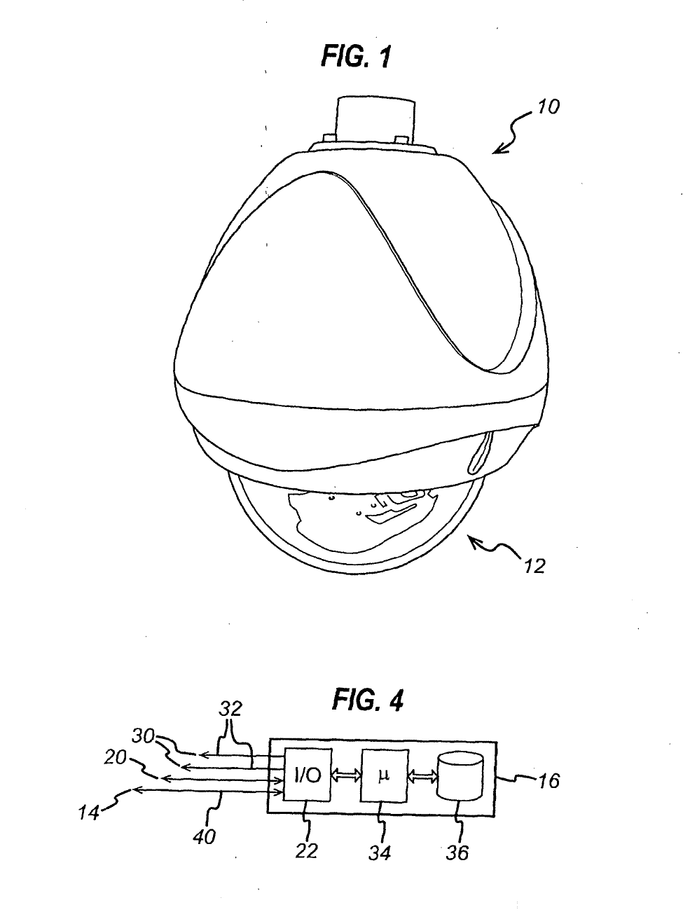

FIG. 3 shows a schematic view of a system 100 according to an embodiment of the present invention. The system includes an apparatus housing 10 such as the CCTV dome shown in FIG. 1, a camera 12, and a remote control terminal 14. The camera 12 may be housed in a camera housing 12a.

The camera 12 of the present invention will now be described in more detail. In the exemplary embodiment shown in FIG. 3, the camera 12 is located in the apparatus housing 10 which can be a CCTV camera housing, such as a CCTV dome, as for example shown in FIG. 1.

The camera 12 includes camera electronics 16 which provides all conventional functionality of a camera (see below). The camera 12 also includes an intelligent control means 18, such as CCTV control means providing all CCTV functionality. It can be seen from FIG. 1 that both the camera electronics 16 and the control means 18 are located inside the camera 12 within its housing 12a. In the exemplary embodiment shown in FIG. 3, the camera electronics 16 is integrated with the control means 18.

In the context of the present invention, the term “integrated” is used with reference to components to mean either hardware components which are linked, for example, mounted on the same circuit board, or functional components embedded together and carried out by an integrated processor and memory (see below with reference to FIG. 3). For example, the camera electronics 16 may comprise a processor, such as an embedded digital processor, a field programmable gate array (FPGA), application specific integrated circuit (ASIC).

All control circuitry is placed within the camera 12 itself (i.e. within the camera housing 12a); this can be done at very small incremental cost using components already present within the camera 12.

The camera 12 also includes an imaging component 20, such as a charge coupled device (CCD) or a complimentary metal-oxide-semiconductor (CMOS). The camera electronics 16 comprises imaging electronics 16a which provides conventional camera functionality and obtains image data from the imaging component 20 and compresses the image data by converting it from an analog to a digital image. The image data is buffered/stored in memory 36 in the camera 12 before further processing by the control means and/or transmission to an external device via a communication interface 22 (see below).

The intelligent control means 18 integrated with the camera electronics 16 comprises a communication interface 22 which is able to communicate with the remote control terminal 14 (external to both the camera 12 and the apparatus housing 10). In one embodiment, the communication interface 22 is configured to communicate with the remote control terminal 14 by receiving and transmitting wired or wireless signals over communication link 40, for example via an Ethernet cable, or wireless link such as a wireless internet connection. Alternatively, the communication interface 22 is configured to communicate with the remote control terminal 14 via signals transmitted and received through wires or fibre-optic cables over a bidirectional communication link. The communication interface 22 is also configured to communicate with a plurality of remote control terminals 14 and other similar or identical camera systems 100 to form a communication network through which each camera 12 can be controlled remotely from one or more remote locations.

In particular, the communication interface 22 in the control means 18 is configured to generate a user interface 24, which is viewable remotely on a screen 26 at the remote control terminal 14. This is done by the communication interface 22 generating interface signals to send to the remote control terminal 14 and responding to control command signals received from the remote control terminal 14. The user interface (generated by the control means 18) provides a menu structure including options pertaining to CCTV functions of the camera. An operator can interact with the user interface 24 at the remote control terminal 14 and can input commands which are transmitted by the remote control terminal 14 and received by the communication interface 22 within the control means 18 of the camera 12. A normal way of inputting commands at the user interface 24 would be through a PC or similar device acting as the remote control terminal 14. After receiving the command, the control means 18 transmits control signals which are received by the camera control electronics 16 for controlling a function of the camera 12. For example, the commands transmitted by the remote control terminal 14 and received by the camera control electronics 16 via the communication interface 22 of the control means 18 of the camera 12 can relate to configuring display options of the user interface 24, configuring video settings of the camera control electronics 16, configuring video alarm settings, providing a programmable motion mask, providing a privacy cursor, providing a mosaic privacy patch, providing a color bar on the display screen 26 of the remote control terminal 14, providing a logo on the display screen 26 of the remote control terminal 14, providing customization of colors, customization of color sets, customization of graphics or customization of logos, providing customization of languages on the user interface 24, or configuring a password for accessing the user interface 24.

The configuration of video alarm settings enables the system 100 of the present invention to trigger an automatic alarm when particular movement (e.g. unusual movement) is detected by the imaging component 20. The camera control electronics 16 then automatically obtains image data containing the unusual movement from the imaging component 20 and compresses the image data as described above. The image data is buffered/stored in memory 36 in the camera 12 and transmitted via the communication interface 22 to the remote control terminal 14 which triggers an alarm based on the image data containing the unusual movement. This way, for example, the system 100 of the present invention is able to detect intruders to a property and signal the presence of the intruder to an operator at the remote control terminal 14

When configuring display options of the user interface 24 and/or configuring video settings of the camera control electronics 16, a portion of the display screen 26 of the user interface 24 may be frozen (i.e. displaying a still image of the last video/image frame) so as to assist an operator in selecting the appropriate setting or option.

The system 100 also includes a motor 28 and a motor drive means 30 (integrated with the motor 28). In the exemplary embodiment shown in FIG. 3, the at least one motor 28 and the motor drive means 30 are located outside the camera 12, but inside the apparatus housing 10 to control movement of the camera within the apparatus housing 10, e.g. pan and tilt movement of the camera.

The motor 28 is a direct drive brushless DC servo motor, whilst the motor drive means 30 comprises drive circuitry and is configured to drive the at least one motor 28 to move the camera 12 and/or the apparatus housing 10 under control of the control means 18. The control means 18 communicates with the motor drive means 30 via an i2c serial signal 32 which is generated and communicated entirely within the apparatus housing 10. This can be achieved because the camera control electronics 16 itself can provide the i2c control stream 32. This provides a very significant cost saving over the usual need to provide additional circuitry for drive power and general control.

In one embodiment, the apparatus housing 10 remains stationary at all times and the at least one motor 28 is configured to move the camera 12 with respect to a mounting element (not shown) to which the camera 12 is connected within the apparatus housing 10 in response to a control signal transmitted by the control means 18 and received by the motor drive means 30 to drive the at least one motor 28 to move the camera 12.

In an alternative embodiment, the apparatus housing 10 is connected to a mounting element (not shown) and is moveable relative to the mounting element in response to a control signal transmitted by the control means 18 and received by the motor drive means 30 to drive the at least one motor 28 to move the apparatus housing 10. In this embodiment, the camera 12 is moveable with the apparatus housing 10 relative to the mounting element. In this way, the control means 18 can control, for example, the rotation and/or tilt of the apparatus housing 10 relative to the mounting element.

The control means 18 is configured to transmit signals which can be received by the motor drive means 30 and/or the camera 12 thereby providing all the functionality of a pan tilt zoom (PTZ) camera.

The control means 18 is also configured to provide control signals to the camera control electronics 16 (specifically the imaging electronics 16a) to control certain imaging/video functions of the camera 12, such as zoom drive, focus drive, provision of auto-focus, automatic iris adjustment, iris adjustment under control of an external source, automatic filter adjustment, filter adjustment under control of an external source, adjustment of exposure speed, adjustment of exposure settings, white/color balance adjustment, or provision of privacy patches.

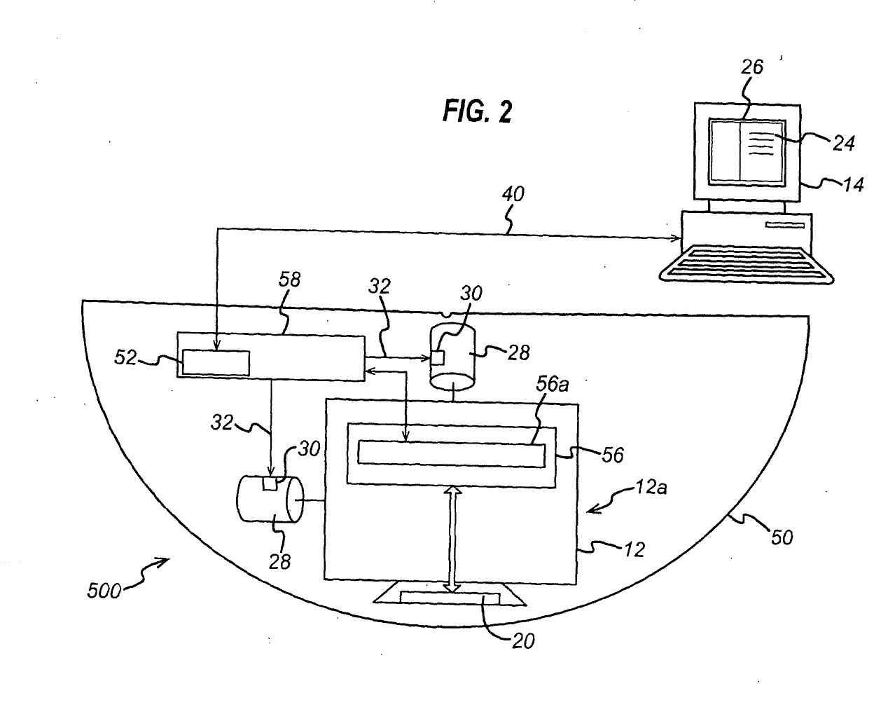

FIG. 4 shows in more detail the camera electronics 16 (incorporating the control means 18) according to an embodiment of the present invention. It can be seen from FIG. 3 that the camera control electronics comprises a microprocessor 34 and memory 36. FIG. 3 also shows the i2c serial link 32 via which the control means communicates with the motor drive means 30 and the motor 28, as well as links via which the camera control electronics 16 communicates with the imaging component 20 and via which the communication interface 22 communicates with the remote control terminal 14 as described hereinbefore and shown in FIG. 2.

In the embodiments described above and shown in FIGS. 3 and 4, all intelligent control and drive components and the entire communication interface for controlling the camera via a user interface are contained entirely within the camera 12 using the camera electronics 16 shown in FIG. 4. The i2c serial link 32 (via which commands are sent by the control means 18 to the motor 28 via the motor drive means 30) are generated and communicated entirely within the apparatus housing 10. This is made possible by the fact that the camera 12 itself and its internal electronics and circuitry are able to generate and provide the i2c serial link 32. Hence, no control circuitry or power drive components required anywhere in the system 100 outside the camera housing, or apparatus housing 10. The only other circuitry required is input power conditioning circuitry (not shown in the figures), which provides a power source to the motors; and surge protection circuitry (also not shown in the figures).

The present invention has been described above in exemplary form with reference to the accompanying drawings which represent a single embodiment of the invention. It will be understood that many different embodiments of the invention exist, and that these embodiments all fall within the scope of the invention as defined by the appended claims.

What is claimed:

1. An apparatus comprising:
a camera including camera electronics; and
a controller configured to provide closed circuit television (CCTV) functionality, wherein the controller is located within the camera;
an apparatus housing in which the camera is located, wherein the apparatus housing is a CCTV camera housing;
at least one motor for moving the apparatus housing and/or the camera relative to a mounting element; and
a motor drive for driving the at least one motor under control of the controller,
wherein the controller is located within the camera and integrated with the camera electronics and comprises a communication interface for receiving and transmitting signals between the controller and a device situated at a location which is remote from the camera.

2. The apparatus of claim 1, wherein the controller is configured to generate a user interface which is viewable from the device at a location which is remote from the camera and is further configured to receive commands from the device at a location which is remote from the camera for control of the controller.

3. The apparatus of claim 1, wherein the camera is moveable under control of the controller.

4. The apparatus of claim 1, wherein the motor drive is integrated with the at least one motor.

5. The apparatus of claim 1, wherein the controller is configured to receive commands and provide control signals for controlling movement of the at least one motor via the motor drive.

6. The apparatus of claim 1, wherein the motor drive and the controller communicate with each other via a signal which is generated by the controller and communicated entirely within the apparatus housing.

7. The apparatus of claim 1, wherein the apparatus housing is stationary and the camera is moveable within the apparatus housing.

8. The apparatus of claim 1, wherein the apparatus housing is connected to the mounting element, the apparatus housing is moveable relative to the mounting element, and the camera is moveable with the apparatus housing relative to the mounting element.

9. The apparatus of claim 1, wherein the controller is configured to provide control signals to the motor drive to control at least one of rotation of the apparatus housing about the mounting element and/or tilt of the apparatus housing relative to the mounting element.

10. An apparatus comprising:
a camera including camera electronics; and
a controller configured to provide closed circuit television (CCTV) functionality;
an apparatus housing in which the camera is located, wherein the apparatus housing is a CCTV camera housing;
at least one motor for moving the apparatus housing and/or the camera relative to a mounting element; and
a motor drive for driving the at least one motor under control of the controller,
wherein the controller is located within the camera and is mounted on common circuitry with the camera electronics and comprises a communication interface for receiving and transmitting signals between the controller and a device situated at a location which is remote from the camera.

11. The apparatus of claim 10, wherein the controller is configured to generate a user interface which is viewable from the device at a location which is remote from the camera and is further configured to receive commands from the device at a location which is remote from the camera for control of the controller.

12. The apparatus of claim 10, wherein the camera is moveable under control of the controller.

13. The apparatus of claim 10, wherein the motor drive is integrated with the at least one motor.

14. The apparatus of claim 10, wherein the controller is configured to receive commands and provide control signals for controlling movement of the at least one motor via the motor drive.

15. The apparatus of claim 10, wherein the motor drive and the controller communicate with each other via a signal which is generated by the controller and communicated entirely within the apparatus housing.

16. The apparatus of claim 10, wherein the apparatus housing is stationary and the camera is moveable within the apparatus housing.

17. The apparatus of claim 10, wherein the apparatus housing is connected to the mounting element, the apparatus housing is moveable relative to the mounting element, and the camera is moveable with the apparatus housing relative to the mounting element.

18. The apparatus of claim 10, wherein the controller is configured to provide control signals to the motor drive to control at least one of rotation of the apparatus housing about the mounting element and/or tilt of the apparatus housing relative to the mounting element.

19. An apparatus comprising:
a camera including camera electronics; and
a controller configured to provide closed circuit television (CCTV) functionality;
an apparatus housing in which the camera is located, wherein the apparatus housing is a CCTV camera housing;
at least one motor for moving the apparatus housing and/or the camera relative to a mounting element; and
a motor drive for driving the at least one motor under control of the controller,
wherein the controller is located within the camera and shares a processor and/or memory with the camera electronics and comprises a communication interface for receiving and transmitting signals between the controller and a device situated at a location which is remote from the camera.

20. The apparatus of claim 19, wherein the controller is configured to generate a user interface which is viewable from the device at a location which is remote from the camera and is further configured to receive commands from the device at a location which is remote from the camera for control of the controller.

21. The apparatus of claim 19, wherein the camera is moveable under control of the controller.

22. The apparatus of claim 19, wherein the motor drive is integrated with the at least one motor.

23. The apparatus of claim 19, wherein the controller is configured to receive commands and provide control signals for controlling movement of the at least one motor via the motor drive.

24. The apparatus of claim 19, wherein the motor drive and the controller communicate with each other via a signal which is generated by the controller and communicated entirely within the apparatus housing.

25. The apparatus of claim 19, wherein the apparatus housing is stationary and the camera is moveable within the apparatus housing.

26. The apparatus of claim 19, wherein the apparatus housing is connected to the mounting element, the apparatus housing is moveable relative to the mounting element, and the camera is moveable with the apparatus housing relative to the mounting element.

27. The apparatus of claim 19, wherein the controller is configured to provide control signals to the motor drive to control at least one of rotation of the apparatus housing about the mounting element and/or tilt of the apparatus housing relative to the mounting element.

28. A system comprising:
the apparatus of claim 1; and
a remote control terminal in communication with the apparatus,
wherein control of the camera is via a user interface presented at the control terminal from data signals received from the controller located within the camera.

29. The system of claim 28, wherein the user interface is generated by the controller.

30. The system of claim 28, wherein the remote control terminal comprises a control interaction means configured to generate control signals which are transmitted to the controller.
